(19) United States
(12) Patent Application Publication
(10) Pub. No.: US 2011/0058165 A1
(43) Pub. Date: Mar. 10, 2011

(54) SAMPLE CELL FOR SPECTROMETRIC ANALYSIS AND METHOD OF USE

(76) Inventors: David Burns, Quebec (CA); Pieter Roos, Verdun (CA)

(21) Appl. No.: 12/666,295

(22) PCT Filed: Jun. 12, 2008
(86) PCT No.: PCT/CA08/01133

§ 371 Date: Jun. 7, 2010

Related U.S. Application Data
(60) Provisional application No. 60/946,868, filed on Jun. 28, 2007.

(51) Int. Cl. G01J 3/28

(52) U.S. Cl. 356/326

(57) ABSTRACT

The present invention relates to a sample cell for spectrometric analysis of light transmitted or reflected after contacting a fluid sample; the sample cell being of a cylindrical shape and having at least one windows and at least one feed conduits at each end; wherein the cylindrical shape is conducive to the propagation of light in a light path along an axial direction through at least one end window; the cylindrical shape having an axial length sufficient to allow analysis of a sample through said end window; the sample cell capable of holding a volume of fluid sample in a bubble free manner. The present invention also relates to a sample cell for spectrometric analysis of light transmitted or reflected after contacting a fluid sample; the sample cell having reflective side walls and a light scattering material within the light path

### BACKGROUND OF THE INVENTION

(a) Field of the Invention

The present invention relates to the field of sample cell for spectrometric analysis of a fluid sample which cell is capable of holding a volume of fluid sample in a bubble free manner.

(b) Description of Prior Art

When measuring fluid samples using optical techniques such as photometry, the samples are typically contained in a vessel referred to as cell or cuvette. These devices contain two sides of optical quality material that allow light to pass through the sample. When analyzing small sample volumes such as volumes of 5 microliters or less conventional sample cells become limiting. The amount of light that transmits through a cell is dependent on the interaction of the light with the analyte contained in the sample volume. A short path length can lead to a less sensitive measurement reading. Therefore it is a challenge to retain high sensitivity while simultaneously reducing the size of the sample cell in order to accommodate minute sample volumes. Furthermore, small sample cells usually are difficult to fill and/or are prone to entrapment of air bubbles that interfere with optical measurement and analysis. Cleaning of a sample cell that accommodates small volumes is often difficult and time consuming.

U.S. Patent Application Publication 2006/0193752 (Levine) describes a microvolume flowcell apparatus that has an oval-shaped aperture with a wide exit channel necking into a thin (approximately 1 mm) channel to allow air bubbles to be trapped away from the light path. In addition, the surface of the flowcell can be treated to reduce air bubble formation by activating the surface using a corona, plasma or flame treatment to create reactive species at the surface that will selectively interact with various gaseous elements that may be present in a reduced atmosphere chamber.

Other patents describe a method that obviate the need of a sample cell, but rely on a liquid droplet suspended between the ends of two opposing multi-mode optical fibers (i.e. U.S. patent application publication 2006/0077390 (Kralik). One source fiber introduces the light onto the droplet while a second detection fiber collects the light that is transmitted. One drawback of not having a sample cell to contain the sample is the short path length and light scattering in the droplet. Furthermore, the size as well as surface tension of sample droplets are subject to variation, which could result in large signal variations.

It would be highly desirable to be provided with a sample cell for spectrometric analysis of a fluid sample which cell is capable of holding a volume of fluid sample in a bubble free manner.

### SUMMARY OF THE INVENTION

In accordance with the present invention there is provided a sample cell for spectrometric analysis of a fluid sample which cell is capable of holding a volume of fluid sample in a bubble free manner.

According to one embodiment of the invention, a sample cell has a cylindrical shape and has at least one window and at least one feed conduits at each end; light is propagating along the axial direction of the cylindrical shape through at least one end window, and the cylindrical shape has an axial length sufficient to allow analysis of the sample through an end window, and the sample cell is capable of holding a volume of fluid sample in a bubble free manner.

This configuration allows for the volume of the sample to be reduced (e.g. less than 15 microliters, and preferably less than 5 μL) while maintaining a long path length through the cylindrical volume in the axial direction. The cross-section of the cylindrical volume could alternatively be oval instead of circular without adversely affecting the performance of these embodiments. The cell can work in transmission or reflection mode. The sample cell can be a flow through cell.

According to another embodiment of the invention, a flow cell device has a feed conduit adapted to facilitate the trapping of air bubbles as a result of the action of fluid flow in the feed conduit. Preferably, the feed conduit and sample cell are adapted to work together to create fluid dynamic conditions that reduce the probability of air bubbles remaining in the sample cell as a small volume of fluid sample is flowed into and through the device. The physics underlying the cell design abolishes formation of micro bubbles and their entrapment, which is a major limitation of conventional design. This mechanism is provided by the arcuate inlet and outlet sections of the sample injector. The loop induces a vortex in the hydrodynamic flow in the cylindrical cell thereby preventing bubbles from being trapped in the dead volume areas. The specific geometry of the arcuate channels is dependent on the size of the bubble that is typically formed.

In accordance with another embodiment in which air bubbles essentially never appear within the optical path of the sample in the cell device, the invention provides a method of preparing samples for analysis, and analyzing the samples without screening or checking for the presence of air bubbles to remove false measurements from the analytical data acquired.

According to one embodiment, the sample cell device is disposable.

For the purpose of the present invention the following terms are defined below.

The term “fluorocarbon polymer” is intended to mean a polymer that contains atoms of fluorine, including, but not limited to, polytetrafluoroethylene (PTFE), Teflon™, and a polymer of fluorinated ethylene. The “fluorocarbon polymer” is characterized by a high resistance to solvents, acids, and bases.

The term “cylindrical” is intended to mean that the shape is elongated having two end being parallel to one another and delimiting its length along an elongated axis and each of the end being joined together by a curved surface generated by a straight line moving along a curve while being substantially perpendicular to the end surfaces.

The term “spectrometry or spectrometric” is intended to mean the analysis of the interaction between matter and radiation across a range of energies, where amplitude and energy are defined for each analysis.

The term “fluid” is intended to mean a subset of the phases of matter, fluids include liquid, gel, and flexible solids. Fluid sample in accordance with the present invention includes, without limitation, a homogeneous solution or heterogeneous mixture which may be a liquid, suspension or gel. The fluid sample is susceptible of being analyzed using the methods of the present invention, such as effluent liquids from various sources, laboratory samples for different purposes including forensic, and biological samples such as aqueous proteinaceous liquid, bacteria and cell suspensions, cell culture media, cell culture components, blood, blood products, blood components, lymph, mucus secretions, saliva, semen, serum, plasma, tears and reconstituted lyophilized feces.

The term “barcode” is intended to mean a machine-readable representation of information in a visual format on a surface. Barcodes store information in a number of ways, including but not limited to: the widths and spacings of printed parallel lines, patterns of dots, concentric circles, and text codes hidden within images. Barcodes are read by optical scanners called barcode readers or scanned from an image by a software (i.e. Smartscan Xpress).

The term “radio-frequency identification” is intended to mean an automatic identification method, relying on storing and remotely retrieving information using devices called radio-frequency identification (RFID) tags, emitters, or transponders. An RFID emitter is an object that can be attached to or incorporated into a product, animal, or person for the purpose of identification using radio waves.

The term “watermark” is intended to mean an image, pattern and/or code embedded into the material that is used to establish ownership and/or authenticity. A watermark may be visible or invisible.

The term “microprinting” is intended to mean a very small printed character and/or text that usually serves to confirm the fact that the item on which it is printed is genuine.

The term “hologram” is intended to mean a flat optical image that looks three-dimensional to the naked eye. A hologram that is pressed onto an item under high temperature can be used as an additional level of protection from creating imitation items.

The term “flow through” is intended to mean the flow or stream of a sample in a continuous progression from the beginning to the end of a sample cell.

All references referred herein are hereby incorporated by reference.

### BRIEF DESCRIPTION OF THE DRAWINGS

FIG. 1 illustrates a perspective view of a tool in accordance with one embodiment of the present invention,

FIG. 2 illustrates a perspective view of a tool in accordance with the embodiment shown in FIG. 1 at a different angle.

FIG. 3 illustrates an exploded perspective view of a tool in accordance with the embodiment shown in FIG. 1.

FIG. 4 illustrates an exploded perspective view of a tool in accordance with the embodiment shown in FIG. 1.

FIG. 5 illustrates a perspective view of a tool in accordance with another embodiment of the present invention.

FIG. 6 illustrates a NMR spectroscopic analysis of an embryo leading to a pregnancy or not.

FIG. 7. Illustrates a NIR spectrum (A) mean variation of 35.8% (B) mean variation of 3.5%

### DETAILED DESCRIPTION OF THE INVENTION

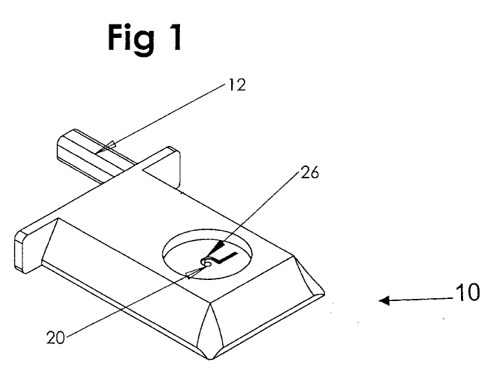

As shown in FIG. 1, the flow cell device 10 has a keyed shape with an abutment end 12 and a handle 12 for insertion into an optical analyzer.

The cell 20 has a volume of about 0.5 to 5 μL, and is filled by injecting fluid into feed tube 22, then feed tube 24 followed by the arcuate channel 26 to a first end of the cylindrical cell 20. Arcuate channels 26 and 28 and cylinder 20 are closed off by windows 16 and 18. Fluid continues to flow out the second end of the cell 20 through the second arcuate channel 28 and the feed tubes 30 and 32. The arcuate channels 26 and 28 have been shown to be efficient in preventing the trapping of air bubbles therein and/or creating flow dynamics within the cell 20 that help prevent air bubbles from sticking to the side wall of the cylindrical cell 20.

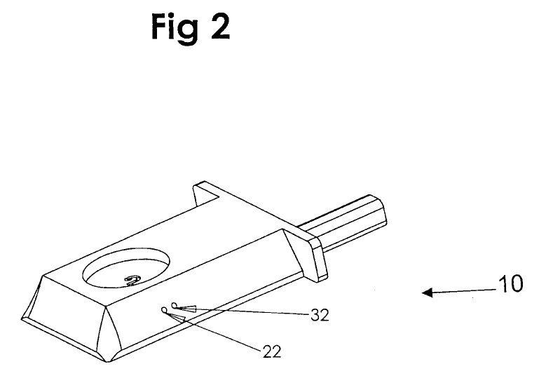

Referring to FIG. 2, feed tubes 22 and 32 measure approximately 0.7 mm in diameter allowing insertion of a standard gel loading tip. Conversely, these channels can be used to connect to a flow system enabling continuous flow through cell 20.

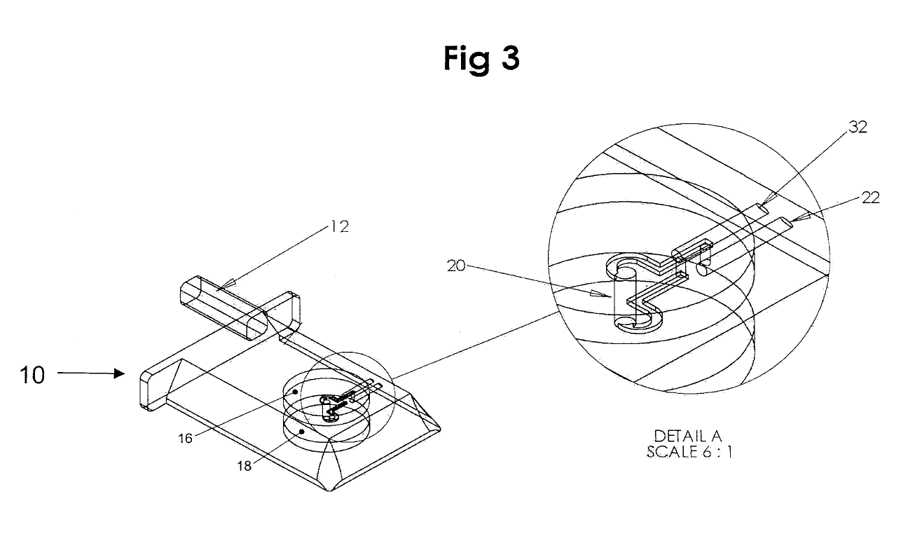

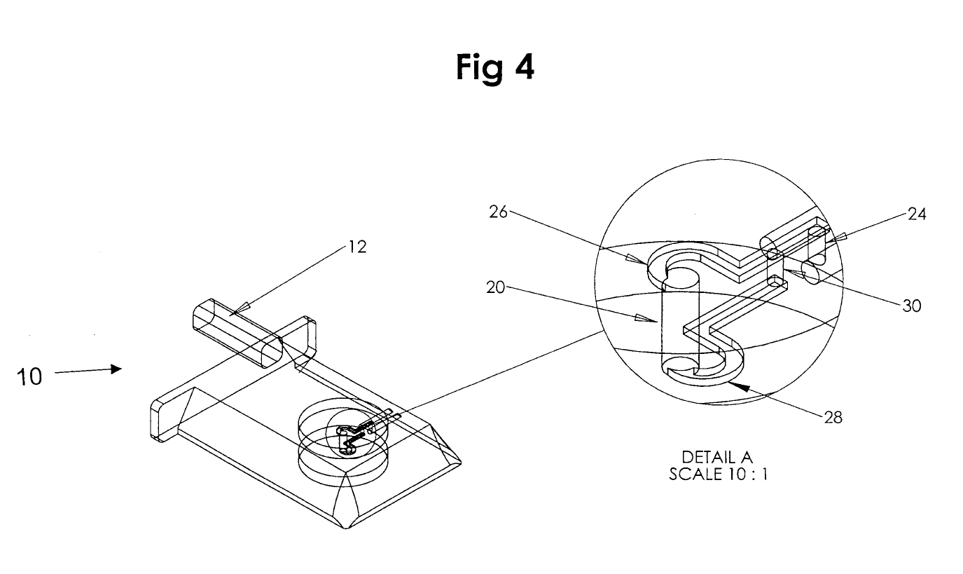

Referring to FIGS. 3 and 4, an exploded view of cell 20, arcuate channels 26 and 28, and feed tubes 22, 24, 30 and 32 are shown. These tubes are interconnected enabling the flow of fluid from inlet channel 22 to exit channel 28. Channel 24 (FIG. 4) enables the fluid from the inlet tube 22 to flow to arcuate channel 26.

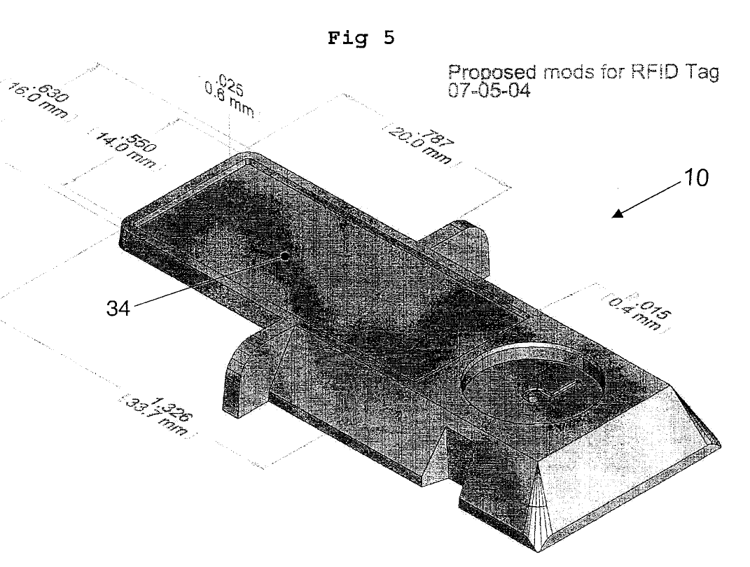

As shown in FIG. 5, a tabular handle 34 can be used to insert the cell 20 into an optical analyzer. The tabular handle 34 can be used to house a means of tracking and/or of authenticating the usage of the sample cell.

The device 10 is for use with a transmission mode optical analyzer. The light enters through window 16 into cell 20 and then exits through window 18. The window 16 material can be glass or plastic and the cell 20 is integrated within a plastic body, such as acrylonitrile butadiene styrene (ABS) or Teflon™, or metal, such as aluminum or stainless steel. The preferred material is ABS which has very little scattering characteristics and rather reflects the light and thus prevents interaction of the light with the cell material. Preferably, the device 10 is molded as one piece in one material with special care on the tolerances of cell 20 to improve signal reproducibility through window 16.

Windows 16 and 18 are held in place by pressure fitting them into cell 20. To ensure a tight seal around the channels, a 25 μm high v shaped edge is made.

To increase the interaction of the light with the sample, it has been found to be efficient to include a scattering material in window 16, such as Teflon™, while using a reflective material, such as aluminum, for the body of cell 20. In this way, the light is lightly scattered at entry to the cell and most of the light makes at least some reflections off the sidewall before exiting. This increases the interaction between the light and sample analyte contained in the cell 20.

The amount of light that transmits through a cell is dependent on the interaction of the light with fluid sample in the sample cell. Shorter path length can lead to less sensitive measurement due to fewer interactions between the light and the fluid sample. Reduction of the sample volume is still possible by reducing the volume of the cell while maintaining a significant path length. By reducing the diameter through which the light passes the volume is reduced considerably. For instance, a cylinder having a diameter of 1 mm and a length of 3 mm will contain a sample volume of only 3 microliters.

The device 10 is preferably for containment of a small fluid sample for the characterization of optical properties such as transmission from UVis to NIR and IR, To improve the precision of the measured analytical signal a light scatter (such as Teflon™) is used in the optical path. The Teflon™ can be placed on the detection and/or transmission side of the cell.

The design of the device 10 allows the introduction of small fluid samples (less than 15 μL and preferably less than 5 μL) without entrapment of air bubbles in the optical path. The introduction channel 26 is designed such that it prevents dead space where air bubbles can be trapped. The introduction of a small fluid sample will completely fill the cell 20 thereby permitting precise measurements of the sample. The cell 20 can have different path lengths depending on specific need and sample volume available. A shorter path length of cell 20 will enable analysis of smaller sample volumes. The device 10 can be manufactured using standard molding processes thereby rendering it affordable and disposable. This feature is especially important when analyzing biological samples where it is necessary to avoid cross contamination or where washing of the cell is not cost effective or even hazardous.

### EXAMPLE 1

### Spectrometric Analysis of Small Volume Samples

The device 10 of the present invention is directed to the analysis of volumes of fluid of 30 μL or less, preferably less than 5 μL. Other micro volume sample cells make use of a trough in which the meniscus created by the small cell volume hampers the optical transmission due to internal reflections and the hampering is inversely correlated with sample volume. The device 10 of the present invention can accommodate a relatively small sample volume which can be analyzed using spectrometric techniques without interference by microbubbles or other limitations of the prior art.

The device 10 of the present invention has a wide range of applications in fields where analyzing small volumes of fluid samples is important. Such fields include, but are not limited to, fields where fluid samples may be available in minute and limited quantities, such as forensics, biology, biochemistry, molecular biology, analytical chemistry, organic and non-organic chemistry, and medicine. Other fields where the device 10 of the present invention may be used are those where reducing the volume of samples assayed represents an economic advantage. This may be achieved in several ways, including but not limited to, reducing the quantity of fluid sample analyzed and/or allowing a larger number of samples to be tested. A representative field where this may be important is environmental testing, where volumes may not be limited, but increasing the number of samples tested for the same cost may be beneficial. Another representative field is high-throughput screening of chemical compounds, where reducing the volume analyzed allows cost reduction both by decreasing the quantity of a given chemical compound used in an analysis and by increasing the number of analyses that may be performed at once.

Yet another example where the device 10 of the present invention is advantageous is in the field of reproductive medicine. According to the Society for Assisted Reproductive Technology (SART) statistics, there were 122 683 IVF cycles performed in US in 2005 and three times more of that number can be estimated world-wide. Average number of embryos transferred per cycle ranged between 2.4 (<35 years of maternal age) and 3.3 (41-42 years). At the same time, pregnancy rates ranged from 43% to 18%. One of the most important complications of in vitro fertilization (IVF) treatment is the high multiple pregnancy rate which leads to a higher incidence of medical, perinatal and neonatal complications and hence to higher health care costs. Single embryo transfer (SET) is an effective way to minimize the risks of multiple pregnancies. Because only one embryo is transferred, the selection of the embryo with an optimum implantation potential is of great importance. The sample cell of the present invention is particularly advantageous for the measurement of near infrared (NIR) spectra of single embryo cultures. Similarly the device 10 of the present invention is advantageous is for the measurement of near infrared (NIR) spectra of culture medium from different maturational stage oocytes maintained individually in culture after ovarian stimulation.

When embryos are grown as single embryo cultures very little media is used (typically 20 μL). With such small volumes available for spectral analysis, a sample cell must be able to accommodate minute volumes of sample; typically much less than 10 μL for the determination of the MR spectra.

The utility of the device 10 of the present invention in the practice of reproduction is illustrated herein by determining whether metabolomic profiling of embryo culture media correlates with reproductive potential of individual embryos. The complete array of small-molecule metabolites that are found within a biological system constitutes the metabolome and reflects the functional phenotype. Metabolomics is the systematic study of this dynamic inventory of metabolites as small molecular biomarkers representing the functional phenotype in a biological system. Using various analytical approaches including spectral measurements, metabolomics attempts to determine and quantify metabolites associated with physiologic and pathologic states.

The present invention will be more readily understood by referring to the following examples which are provided to illustrate the invention rather than to limit its scope.

In this example, it is presented that embryos that result in pregnancy may be differentiated from those embryos that do not result in pregnancy by their metabolomic profile, and that the difference may be detected by the rapid assessment of the embryo culture media using targeted spectroscopic analysis of small volumes of embryo cultures using the sample cell of the present invention.

Material and Methods

Samples. Thirty-three spent media samples from 14 patients with known outcome (0 or 100% sustained implantation rates) were individually collected after embryo transfer on day 3, and evaluated by Near Infrared (NIR) spectroscopy using the device 10 of the present invention. Prior to analysis, in vitro fertilization (IVF) media samples were thawed at room temperature (25° C.) for 30 minutes. The samples were then centrifuged for 10 minutes at 13,000 RPM and stored on ice until analysis.

Data acquisition. NIR measurements of randomized samples were conducted using an InGaAs spectrometer with a 512-bit photodiode detector and a Tungsten light source (B&WTek, Newark, Del.). A sample cell of the present invention having a 3 mm path length was filled with 7 μL of sample media for spectral measurement. The device 10 was rinsed with 0.1M sodium hydroxide (NaOH) followed by distilled Milli-q water before each measurement. NIR spectra were recorded from 900-1700 nm at a temperature of 21.0° C.±0.1° C. Control media samples were used to compensate for any drift in signal, and ratios of sample spectra to control media spectra were calculated. The mean of the resulting spectra was determined and subtracted from all of the sample spectra.

Data analysis. Sample properties predictive of pregnancy outcome were quantified from the resulting mean centered NIR spectra by determining the most parsimonious combination of variables in selected wavelength domains using a genetic algorithm (GA) optimization. Selected wavelength regions were weighted by a coefficients calculated by inverse least-squares regression. Viability indices reflective of reproductive potential were calculated for each sample. To avoid random correlations, each sample's pregnancy viability was estimated in a continuous reproductive potential index by a leave one out cross validation approach. Notch box plots were used to plot the resulting viability indices, and t-tests were applied to determine significant differences between “pregnant” and “non-pregnant” groupings. Sensitivity and specificity of predicting viability (described as implantation and delivery) were calculated.

Results

Culture media from a total of 33 embryos from 14 patients were evaluated with NIR spectroscopy. Of the 33 embryos transferred, 16 implanted and lead to delivery (100% implantation), and 17 did not implant (0% implantation). All samples were analyzed successfully and were included in the data analyses.

NIR spectra were analyzed using the approach described above, signals were mean-centered by subtracting the mean at each wavenumber, and mean values were calculated for each study group. GA optimization was used and four areas in the spectroscopic range of NIR were identified and were given a relative weighting as most discriminatory between the two study groups. Using the mathematical model that takes into account these regions and their weights, a viability index was calculated.

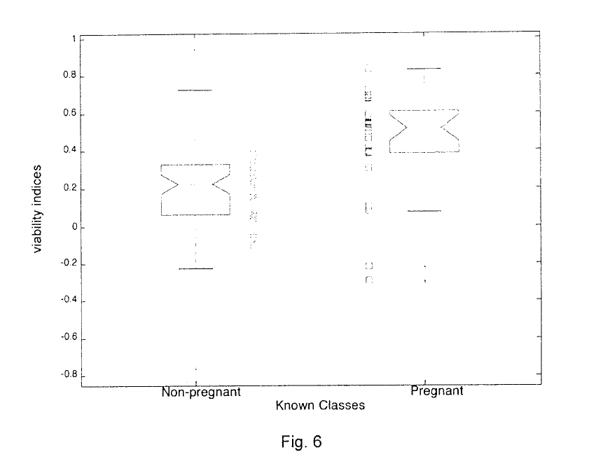

NIR spectroscopic analysis of spent culture media of embryos with proven reproductive potential demonstrated higher viability indices (0.6712+0.27615) than those that failed to implant (0.29227+0.22355) (P<0.05)(FIG. 6). NIR spectroscopy identified implantation/pregnancy potential with a sensitivity of 75% and a specificity of 83.3%.

### EXAMPLE 2

### Effects of Air Bubbles on Reproducibility of Measurements

The designed device 10 of the present invention focuses on the measurement of volumes of fluid in a bubble free manner. The device 10 of the present invention comprises features that abolish formation of micro bubbles and their entrapment from the sample. The present example shows the comparison of a device 10 of the current design with an arcuate feed conduit to a sample cell of a similar design with a straight feed conduit.

Materials and Methods

Samples. Prior to analysis, in vitro fertilization (IVF) media samples were thawed at room temperature (25° C.) for 30 minutes. These samples were centrifuged for 10 minutes at a speed of 13,000 RPM and stored on ice until analysis.

Data acquisition. NIR measurements of randomized samples were conducted using an InGaAs spectrometer with a 512-bit photodiode detector and a Tungsten light source (B&WTek, Newark, Del.). A sample cell with a 3 mm path length was filled with 7 μL of sample media for spectral measurement. The cell was rinsed with 0.1M sodium hydroxide (NaOH) followed by distilled Milli-q water before each measurement. NIR spectra were recorded from 580-1100 nm at a temperature of 21.0° C.±0.1° C.

Data analysis. Ten samples were analyzed for each sample cell type. The recorded NIR spectra were averaged and relative standard deviation was calculated for each set and the percentage variation of light intensities between wavelength 580-1100 nm was computed. These values were then plotted for each sample cell.

Results

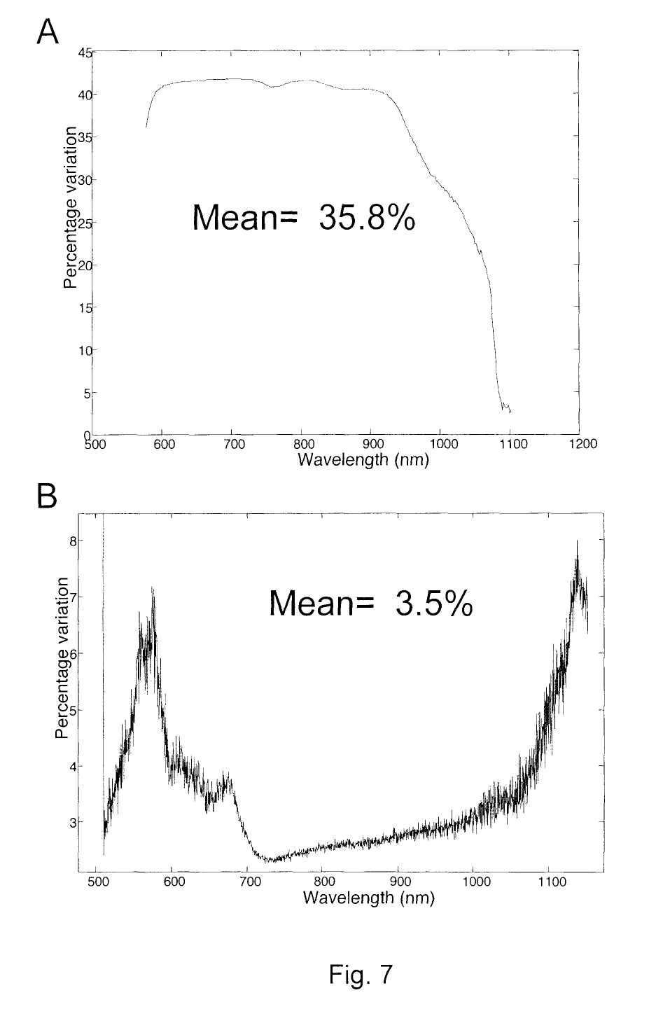

Measurement from a sample cell lacking an arcuate feed conduit displayed a mean percentage variation of 35.8% (FIG. 7A), while a sample cell with an arcuate feed conduit displayed a mean percent variation of 3.5% (FIG. 7B).

The addition of an arcuate feed conduit in the design of the present device 10 affects fluid dynamics and prevents the formation of micro bubbles, resulting in more stable intensity measurements 10-fold less variable than in a sample cell lacking this improvement.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

1. A sample cell for spectrometric analysis of light transmitted or reflected after contacting a fluid sample; said sample cell being of a cylindrical shape and having at least one window and at least one feed conduits at each end; wherein said cylindrical shape being conducive to the propagation of light in a light path along an axial direction through at least one end window; said cylindrical shape having an axial length sufficient to allow analysis of said sample through said end window; said sample cell capable of holding a volume of fluid sample in a bubble free manner.

2. The sample cell of claim 1, wherein said cylindrical shape has reflective side walls and further comprises a light scattering material within the light path.

3. The sample cell of claim 2, wherein said light scattering material is a fluorocarbon polymer.

4. The sample cell of claim 1, wherein said feed conduit is of an arcuate shape to prevent air bubble trapping.

5. The sample cell of claim 1, wherein said spectrometry analysis is performed using a spectrometric technique chosen from absorption spectrometry and/or emission spectrometry.

6. The sample cell of claim 5, wherein said spectrometry analysis is performed using a spectrometric technique chosen from photometry, fluorimetry, and/or phosphorimetry.

7. The sample cell of claim 1, wherein said spectrometry analysis is performed using a mode chosen from either transmission or reflection.

8. The sample cell of claim 1, wherein said cylindrical shape is circular or oval.

9. The sample cell of claim 1, wherein the axial length is capable of holding a sample volume of a fluid of 30 microliters or less.

10. The sample cell of claim 9, wherein said volume of fluid is 5 microliters or less.

11. The sample cell of claim 10, wherein said volume of fluid is between 2 and 5 microliters.

12. The sample cell of claim 1, wherein said sample cell is a flow through cell.

13. The sample cell of claim 1, further comprising means of tracking the usage of the sample cell.

14. The sample cell of claim 1, further comprising means of authenticating the sample cell.
